(19) United States
(12) Patent Application Publication
(10) Pub. No.: US 2026/0094457 A1
(43) Pub. Date: Apr. 2, 2026

(54) REAL-TIME IMAGE CLASSIFICATION

(71) Applicants: Florida Power & Light Company, Juno Beach, FL (US); Inventus Holdings, LLC, Juno Beach, FL (US)

(72) Inventors: DONVILLE D. SMITH, HOPE SOUND, FL (US); MINH A. NGUYEN, PALM BEACH GARDENS, FL (US)

(21) Appl. No.: 18/903,254

(22) Filed: Oct. 1, 2024

(51) Int. Cl. G06V 20/70; G06V 10/764; G06V 20/17

(52) U.S. Cl. CPC G06V 20/70; G06V 10/764; G06V 20/17

(57) ABSTRACT

One example relates to an image classification system that includes a memory for storing machine-readable instructions and a processor core for accessing the machine-readable instructions and executing the machine-readable instructions as operations. The operations include accessing a set of images. An image of the set of images includes image timing information. The operations also include accessing a set of user-selected labels. A label of the set of user-selected labels includes label timing information. The operations additionally include determining a time relationship between the set of images and the set of user-selected labels. The operations further include associating the label with the image based on the image timing information, the label timing information, and the time relationship. Additionally, the operations include outputting an indication of the association of the label with the image.

### TECHNICAL FIELD

This description relates to systems and methods that facilitate user classification of images in real-time.

### BACKGROUND

Humans use a camera or other image capturing device to take video or still images of objects in a variety of contexts where the labeling or classification of what is shown in the video/image is important. One example context is using a camera mounted on an unmanned aerial vehicle (UAV) or other drone to remotely survey a solar field to identify any damage or malfunctions, which can result from a number of causes. Another example context is using a handheld camera to capture images and/or video of a home or other building in connection with a walkthrough inspection. Other example contexts include using a UAV to survey the roof of a house or other building in connection with identifying damage to the roof and using a UAV-mounted or handheld camera to review a work or construction site in connection with an inspection. After capturing the image(s)/video(s), operators replay video or review all images and manually label or classify them.

### SUMMARY

A first example relates to a system that includes an image capturing device configured to capture a set of images based on a first set of user inputs. An image of the set of images includes image timing information. The system also includes an electronic labeling device configured to generate a set of labels based on a second set of user inputs. A label of the set of labels includes label timing information. The system additionally includes a memory for storing machine-readable instructions and a processor core for accessing the machine-readable instructions and executing the machine-readable instructions as operations. The operations include accessing the set of images and the set of labels. The operations also include determining a time relationship between the image capturing device and the electronic labeling device. The operations additionally include associating the label with the image based on the image timing information, the label timing information, and the time relationship. The operations further include outputting an indication of the association of the label with the image.

A second example relates to a non-transitory machine-readable medium having machine executable instructions for an image classification system that causes a processor core to execute operations. The operations include accessing a set of images. An image of the set of images includes image timing information. The operations also include accessing a set of user-selected labels. A label of the set of user-selected labels includes label information. The operations additionally include determining a time relationship between the set of images and the set of user-selected labels. The operations further include associating the label with the image based on the image timing information, the label timing information, and the time relationship. Additionally, the operations include outputting an indication of the association of the label with the image.

A third example relates to an electronic labeling device that includes a user interface and a timing unit. The electronic labeling device also includes a memory for storing machine-readable instructions and a processor core for accessing the machine-readable instructions and executing the machine-readable instructions as operations. The operations include outputting a set of displayed labels via the user interface. Each displayed label of the set of displayed labels indicates a potential image classification. The operations also include receiving a first set of user inputs selecting a set of labels. A label of the set of labels is selected from the set of displayed labels. The label includes label timing information indicating when the label is selected based on the timing unit, and the label indicates a classification of an image of a set of images. The operations additionally include outputting the set of labels via the display, wherein outputting the label comprises outputting the label timing information.

### BRIEF DESCRIPTION OF THE DRAWINGS

FIG. 1 illustrates a diagram showing a system that allows a user to perform real-time classification of images, in accordance with an example.

FIG. 2 illustrates an example image of an electronic labeling device configured for use with a drone-mounted image capturing device, showing options for capturing a new set of images and for reviewing previously captured and labeled images.

FIG. 3 illustrates an example image of an electronic labeling device configured for use with a drone-mounted image capturing device, showing a current location and time of the electronic labeling device, useable for determining a relative time and/or location between the electronic labeling device and the image capturing device.

FIG. 4 illustrates an example image of an electronic labeling device configured for use with a drone-mounted image capturing device, showing an example time-dependent quick-response (QR) code for synchronization of an image capturing device with the electronic labeling device in connection with real-time classification of images.

FIG. 5 illustrates an example image of an electronic labeling device configured for use with a drone-mounted image capturing device, showing a set of displayed labels for real-time classification of images related to failures in photovoltaic (PV) modules.

FIG. 6 illustrates an example image of an electronic labeling device configured for use with a drone-mounted image capturing device, showing a set of labeled images for user review.

FIG. 7 illustrates an example image of an electronic labeling device configured for use with a drone-mounted image capturing device, showing a set of labeled images for upload to a server.

FIG. 8 illustrates an example image of an electronic labeling device configured for use with a drone-mounted image capturing device, showing multiple sets of labeled images uploaded to a server and available for viewing and/or reviewing.

FIG. 9 illustrates an example computing environment implementing an image classification system capable of classifying images via associating the images with user-selected labels.

FIG. 10 illustrates a flowchart of a method of classifying images in real-time based on user input.

### DETAILED DESCRIPTION

Various examples described herein provide for real-time labeling of images by associating image labels with images based on various criteria. Examples include providing a user with a set of displayed labels to select a label from to associate with an image. The user selects the label via an electronic labeling device (e.g., a mobile device such as a phone, tablet, etc. executing mobile application software (e.g., an “app”), etc.) at or near the same time that the user captures the image via an image capturing device (e.g., a camera, etc.). In some examples, the image capturing device is on a remotely operated device such as an unmanned aerial vehicle (UAV) or drone, and the drone controls include controls for capturing images via the image capturing device.

In various examples in which the electronic labeling device and the image capturing device are associated with distinct devices, a time relationship (e.g., timing unit offset, etc.) and/or location offset between the electronic labeling device and the image capturing device is determined. The time relationship is used by various examples along with time metadata of image(s) and time metadata of label(s) to associate image(s) with label(s). Labeled image(s) are sorted in various examples based on the associated label(s). A set of displayed labels can be selected by a user, for example, prior to capturing image(s), based on a context or scenario. Examples of such contexts or scenarios include UAV inspection of solar panels, large site inspections, construction field inspections, home roof inspections, distribution equipment, etc.

Various examples provide for more efficient image labeling than conventional techniques, which involve an operator replaying video or reviewing all images after capture and manually labeling or classifying those images. Compared to a potential machine learning approach, examples herein provide multiple advantages, such as reduced computational and data storage overhead, reduced development and training time, and improved accuracy of image labeling, given that a machine learning approach would include user classifications as ground truth for training.

By providing a user the opportunity to label images at or near the time the user captures the image, image labeling accuracy is based on concurrent user knowledge of why that user captured the image (e.g., or video/video segment, etc.). Thus, various examples curtail any recall-based errors that may occur in manual review (e.g., especially with a large set of images), as well as image classification errors that occur from even a well-trained machine learning model.

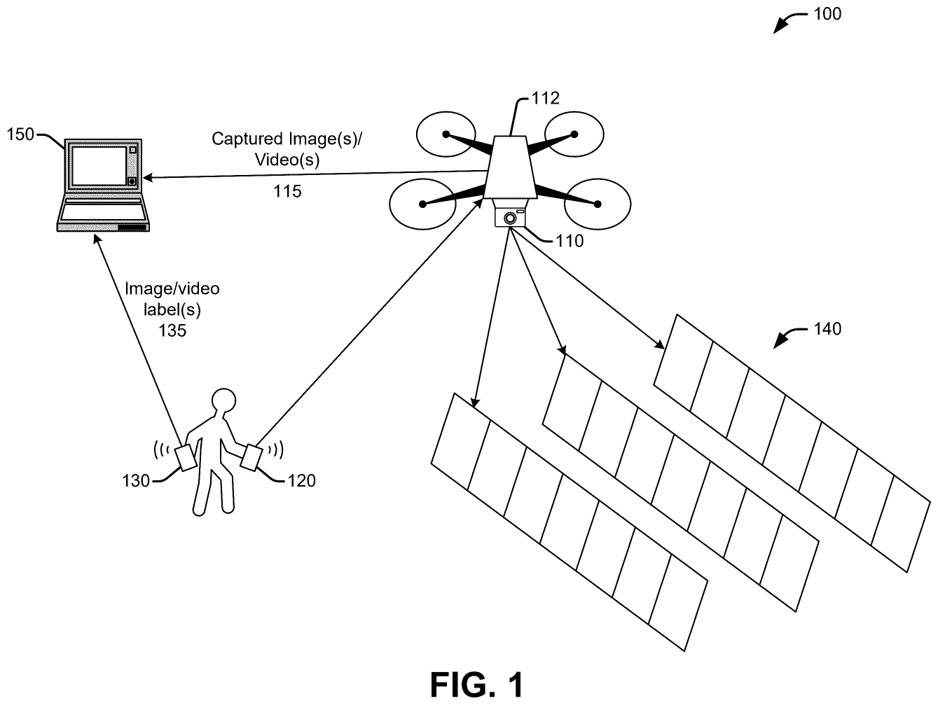

Referring to FIG. 1, illustrated is a diagram showing a system 100 that allows a user to perform real-time classification of images. The system 100 includes an image capturing device (e.g., a camera, etc.) 110, which in the example of FIG. 1 is included in a UAV 112, although in various other examples the image capturing device 110 is a separate device or included in a different system or vehicle. The image capturing device 110 captures images (e.g., a set of images, videos, pixelated images, infrared images, light detection and ranging (LIDAR) images/videos, etc.), based on user inputs received via a user interface 120 that controls the image capturing device 110. Each image/video 115 captured by the image capturing device 110 can include image/video metadata that indicates one or more of a time the image/video was captured, a location where the image/video was captured, and/or additional information (e.g., image dimensions, file size, settings of the image capturing device, etc.). In various examples, the user interface 120 additionally controls a UAV or other vehicle that includes the image capturing device 110, allowing the user to remotely maneuver the image capturing device into selected positions to capture images/videos 115.

At or near the time an image/video 115 is captured by the image capturing device 110, the user provides additional user inputs through an electronic labeling device 130 to select a label (e.g., indicating a classification, category, etc.) 135 for the image/video via user inputs to the electronic labeling device 130, for example, by selection from a set of displayed labels output via a display of the electronic labeling device 130, by typing in the label 135 or a code associated with the label 135, etc. The label(s) 135 selected via the electronic labeling device 130 can include label timing information (e.g., label timestamp(s) of when the label(s) 135 were created via user selection, information indicating a time relative to a synchronization output from the electronic labeling device 130, etc.). In various examples, the electronic labeling device 130 is a mobile device such as a phone, tablet, etc. executing mobile application software (e.g., an “app”). While the label 135 is selected at approximately the same time as the image/video 115 is captured, in many situations a user selects the label 135 shortly after (or shortly before) the user captures the image/video 115 via the image capturing device 110.

In various example scenarios, the image capturing device 110 captures images/videos 115 within a context or setting 140, such as the example photovoltaic (PV) modules shown at 140 in FIG. 1. Examples are employable in a range of scenarios, and prior to capturing images/videos 115, the set of displayed labels are selectable via the electronic labeling device 130 based on the context/setting, such as a set of displayed labels for potential causes of PV module failures in connection with a planned set of images at a solar power plant (e.g., as shown in FIG. 1), a set of displayed labels for potential issues with the roof of a house in connection with a home inspection, set(s) of displayed labels for types of damage in connection with an insurance-related inspection of property (e.g., home, business, vehicle, etc.), a set of displayed labels for potential risks/hazards at a work site in connection with a safety inspection, etc.

The set of images/video(s) 115 captured by the image capturing device 110 and the set of labels 135 for the set of images/videos 115 are provided to an image classification system 150, which associates labels of the set of labels 135 with images/videos of the set of images/videos 115. In various examples, the image classification system 150 associates label(s) 135 with image(s)/video(s) 115 based on one or more of image/video timing information (e.g., image/video timestamp(s), a relative time to when a synchronization data point was captured via the image capturing device, etc.) of the image(s)/video(s) 115, the label timing information of the label(s) 135, a time relationship (e.g., a relative timing unit offset, etc.) between the image capturing device 110 and the electronic labeling device 130 (e.g., in examples where the image capturing device 110 and the electronic labeling device 130 are separate devices, etc.), a time threshold for label selection, and/or an estimated user delay between images/videos of the set of images/videos 115 and labels of the set of labels 135.

In one example, a label 135 has label timing information able to be represented numerically (e.g., a label timestamp, etc.) and an image 115 has image timing information able to be represented numerically (e.g., an image timestamp, etc.). In the example, the label 135 is associated with the image 115 based on the image timing information of the image 115 being the closest in time (e.g., having a minimum time difference, etc.) among the images 115 or a subset of the images 115 to the label timing information of the label 135 (e.g., after the label timing information and/or image timing information are adjusted based on the time relationship, etc.). In various examples, the subset of the images 115 is: images 115 captured after the label 135 was determined, images 115 captured before the label 135 was determined, images 115 captured within a time threshold of when the label 135 was determined, images 115 captured within a time threshold before when the label 135 was determined, images 115 captured within a time threshold after when the label 135 was determined, etc.

In various examples where the image capturing device 110 and the electronic labeling device 130 are separate devices, a time relationship (e.g., relative time, etc.) and/or relative location between the image capturing device 110 and the electronic labeling device 130 is determined. Various examples determine the time relationship based on timing information determined (e.g., manually and/or automatically, etc.) between the image capturing device 110 (e.g., and/or image(s)/video(s) 115 captured by the image capturing device 110, etc.) and the electronic labeling device 130 (e.g., and/or label(s) 135 selected via the electronic labeling device 130, etc.).

In some examples, the time relationship is determined automatically, such as via the image capturing device 110 capturing a synchronization data point (e.g., which includes associated timing information such as a timestamp, etc.) based on a synchronization output (e.g., which can be time-dependent, etc.) generated by the electronic labeling device 130. In some examples, the synchronization output is a time-dependent signal transmitted (e.g., wirelessly, via a temporary or non-temporary wired connection, etc.) by the electronic labeling device 130 and the synchronization data point includes the synchronization output as received by the image capturing device 110. In other examples, the synchronization output is generated via a display of the electronic labeling device 130 and the synchronization data point includes an image/video of the synchronization output captured via the image capturing device 110. In some such examples, the electronic labeling device 130 generates a synchronization output that is or includes a time-dependent pattern (e.g., a quick-response (QR) code, etc.) that can change with a frequency that is selected based on a desired precision for determining the relative time, such as every second or every x seconds for some positive number x (e.g., every 0.5 seconds, every 2 seconds, every 3 seconds, etc.). As an example, the time-dependent pattern is associated with a known time from a timing unit (e.g., a clock, etc.) of the electronic labeling device 130 used for determining label timing information (e.g., label timestamp(s), etc.) of label(s) 135. Therefore, the time-dependent pattern can indicate an approximate real-time or time interval(s) of a local timing unit on the electronic labeling device 130.

In some such examples, the synchronization data point includes a synchronization image of the time-dependent pattern captured by the image capturing device 110, and the synchronization image includes timing information (e.g., a timestamp of the synchronization image corresponding to the real-time that the synchronization image was captured by the image capturing device 110 based on a local timing unit on the image capturing device 110, etc.). The relative time between the image capturing device 110 and the electronic labeling device 130 is able to be determined based on the known time from the timing unit of the electronic labeling device 130 and the known time from the timing unit of the image capturing device 110. In various examples, the time from the timing unit of the electronic labeling device 130 is known from the time-dependent pattern (e.g., QR code, etc.) captured in the synchronization image. Additionally, in various examples, the time from the timing unit of the image capturing device 110 is based on the timing information (e.g., timestamp, etc.) of the synchronization image captured by the image capturing device 110.

In the same or other examples, the time relationship is determined manually. In some examples, the time relationship is determined manually via the user taking an action substantially simultaneously (e.g., simultaneously except for unintended small delays due to user reflexes, etc.) via the image capturing device 110 and the electronic labeling device 130 (e.g., pressing “synchronization” buttons on the image capturing device 110 and the electronic labeling device 130, etc.). In other examples, attempts to determine the time relationship automatically fail and the time relationship is instead determined based on information entered manually.

In some examples, the synchronization data point captured by the image capturing device 110 has insufficient information to determine timing information (e.g., because of noise in an output signal, a time-dependent pattern partially or wholly obscured such as by reflected sunlight or an obstruction, etc.) regarding when the electronic labeling device 130 sent the synchronization signal. In such examples, a user manually enters timing information of the synchronization data point captured by the image capturing device 110, which is used with a time frame during which the synchronization signal was output by the electronic labeling device 130 to determine a time relationship between the image capturing device 110 and the electronic labeling device 130.

In the same or other examples, the synchronization data point captured by the image capturing device 110 again has insufficient information to determine timing information regarding when the electronic labeling device 130 sent the synchronization signal. However, in some such examples, the synchronization signal contains additional data (e.g., the time-dependent pattern is displayed via electronic labeling device 130 along with a time from a timing unit of the electronic labeling device 130, etc.) allowing a user to determine timing information of the synchronization signal to enter manually (e.g., along with the timing information of the synchronization data point, etc.).

In various scenarios, a user frequently establishes a pattern wherein the user captures an image/video 115 via the image capturing device 110 followed by inputting a label 135 via the electronic labeling device 130 (or selecting the label 135 followed by capturing the image/video 115) with a delay between capturing the image/video 115 and selecting the label 135 that occurs within a range of delays that is predictable from user inputs. Various examples determine an estimated user delay between capture of the image/video 115 and selection of the label 135. In some such examples, the estimated user delay is used in determining associations between the image(s)/video(s) 115 and the label(s) 135.

In some examples, the association between an image/video 115 and a label 135 is based on a time threshold for label selection. The time threshold indicates a window of time after and/or before an image/video 115 is captured via the image capturing device 110 during which a label 135 selected via the electronic labeling device 130 is associated with the image/video 115. In various examples, the time threshold has a preset value (e.g., 2 seconds before or after the image/video 115 is captured, etc.) and/or is user defined. In scenarios in which no labels 135 or multiple labels 135 are selected within the time threshold for an image/video 115, the image/video 115 can be provided to a user for review (e.g., along with any labels 135 within the time threshold and/or one or more labels 135 not within the time threshold of any image/video 115, etc.).

An estimated user delay determines an approximate delay or range of delays for a given user between capturing images/videos 115 and selecting labels 135. In various examples, an estimated user delay is determined based on images/videos 115 captured and labels 135 selected in one or more scenarios or sessions associated with the same user, and in some examples is maintained in a user profile for the user. In such examples, the estimated user delay is updated as the user captures and labels additional sets of images/videos 115 and/or based on user feedback to associations between labels 135 and images/videos 115.

For example, a first user normally selects a label 135 and then shortly thereafter (e.g., 1.5 to 3.2 seconds after, etc.) captures an image/video 115, while a second user normally captures an image/video 115 and then shortly thereafter (e.g., 1.0 to 2.2 seconds, etc.) selects a label 135. In one example wherein estimated user delay is used in associating labels 135 to images/videos 115, a first label 135 selected by the second user (e.g., estimated to select labels 1.0 to 2.2 seconds after capturing images, etc.) 1.8 seconds after capturing a first image/video 115 is automatically associated with the first image/video 115, while a second label 135 selected by the second user 10 seconds after capturing a second image/video 115 is not automatically associated with the second image/video 115 (e.g., and in some examples is presented to the second user for review, etc.).

In the same or other examples, selection of a single label 135 via the electronic labeling device 130 is associated with a set of images/videos 115 (e.g., one image/video, two or more images/videos, etc.). In various examples, a latching mode is available wherein a first set of image(s)/video(s) 115 is associated with a first label 135 selected via the electronic labeling device 130, each image/video captured via the image capturing device 110 in a first set of image(s)/video(s) 115 is associated with the first label 135 based on various factors. For example, image(s)/video(s) 115 captured after a first label 135 is selected but before a second label 135 is selected are associated with the first label 135, image(s)/video(s) 115 captured after the second label 135 is selected but before a third label 135 is selected are associated with the second label 135, etc. In various examples, the factors include image/video timing information of the first set of image(s)/video(s) 115, the label timing information of the first label 135 and one or more other labels 135 (e.g., a second label 135 selected before the first label 135 and/or a third label 135 selected after the first label 135, etc.), a time relationship between the image capturing device 110 and the electronic labeling device 130, a time threshold for label selection, and/or an estimated user delay between images/videos of the set of images/videos 115 and labels of the set of labels 135.

As one specific example, a first label 135 is selected at 12:00 PM, a second label 135 is selected at 12:01 PM, and a third label 135 is selected at 12:02 PM (e.g., with times per the timing unit of the image capture device 110 or the timing unit of the label selection device 130). A first set of images 115 is captured after 12:00 PM and before 12:01 PM, a second set of images 115 is captured after 12:01 PM and before 12:02 PM, and a third set of images 115 is captured after 12:02 PM (e.g., with times per the same timing unit as used for the first, second, and third labels 135).

In the example shown in FIG. 1, the image capturing device 110, the user interface 120, the electronic labeling device 130, and the image classification system 150 are shown as distinct devices. However, in various examples, two, three, or all of the image capturing device 110, the user interface 120, the electronic labeling device 130, and the image classification system 150 are included within the same device, such as: a device (e.g., a mobile device executing an app, etc.) that includes both the electronic labeling device 130 and the classification system 150; a device (e.g., a mobile device executing an app, etc.) that includes the user interface 120, the electronic labeling device 130, and the image classification system 150; a device (e.g., a mobile device executing an app, etc.) that includes the image capturing device 110, the user interface 120, the electronic labeling device 130, and the image classification system 150; or other combinations.

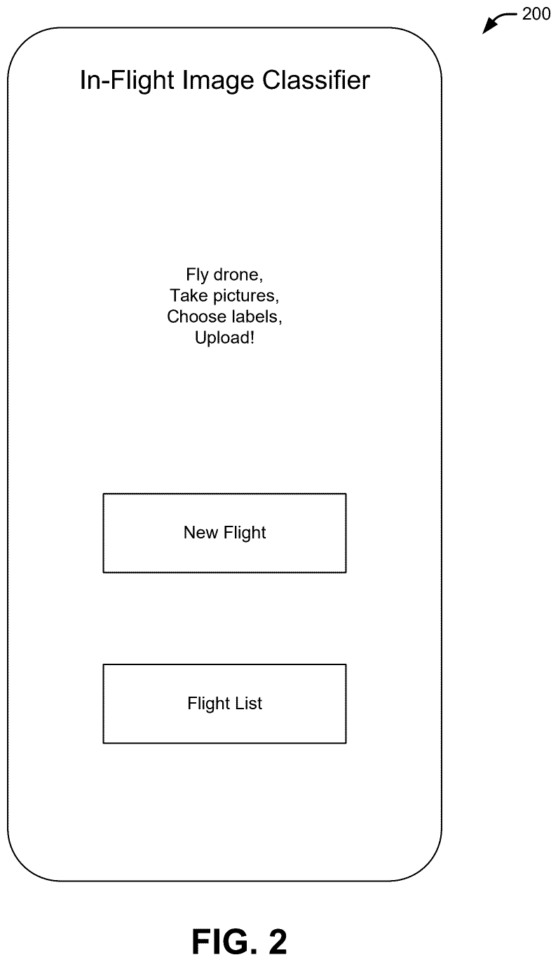

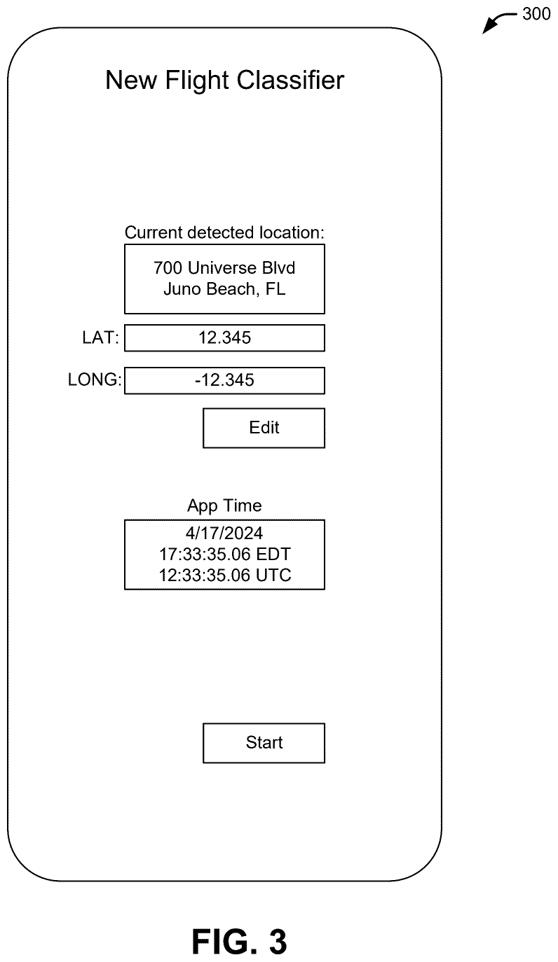

Referring to FIG. 2, illustrated is an example image of an electronic labeling device 200 (e.g., a mobile device executing an app, as an example of the electronic labeling device 130, etc.) configured for use with a drone-mounted image capturing device (e.g., the image capturing device 110, a camera, etc.), showing options for capturing a new set of images (“new flight”) and for reviewing previously captured and labeled images (“flight list”). Referring to FIG. 3, illustrated is an example image of an electronic labeling device 300 (e.g., a mobile device executing an app, as an example of the electronic labeling device 130, etc.) configured for use with a drone-mounted image capturing device (e.g., the image capturing device 110, a camera, etc.), showing a current location and time of the electronic labeling device 300, useable for determining a relative time and/or location between the electronic labeling device 300 and the image capturing device (e.g., the image capturing device 110, etc.).

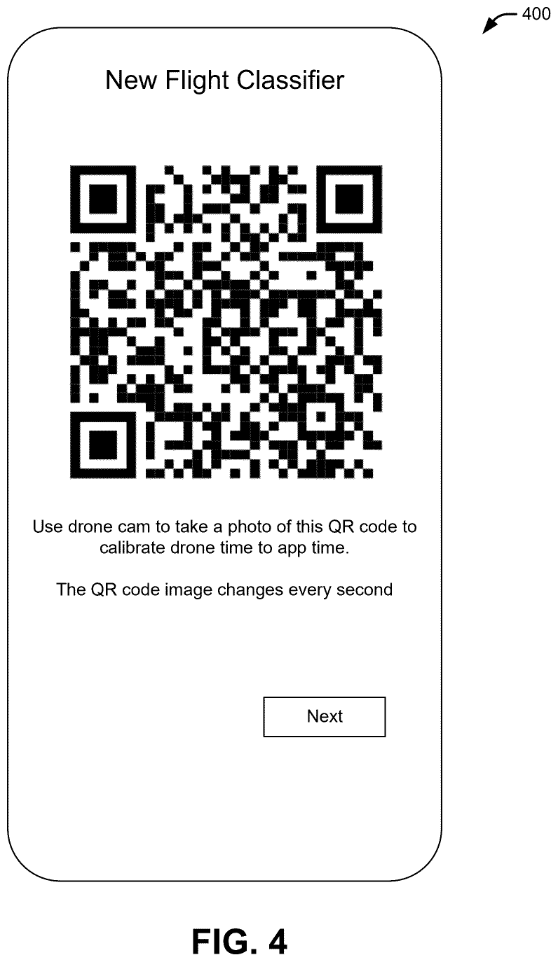

Referring to FIG. 4, illustrated is an example image of an electronic labeling device 400 (e.g., a mobile device executing an app, as an example of the electronic labeling device 130, etc.) showing an example time-dependent QR code (e.g., as an example of a time-dependent pattern, etc.) for synchronization of an image capturing device (e.g., the image capturing device 110, a camera, etc.) with the electronic labeling device 400 in connection with real-time classification of images/videos. In various examples, a time-dependent pattern such as the time-dependent QR code of the electronic labeling device 400 is displayed on an electronic labeling device (e.g., the electronic labeling device 130, etc.) and an image of the time-dependent pattern is captured by an image capturing device (e.g., the image capturing device 110, etc.) as a synchronization image to determine a time relationship between an image capturing device (which determines the timing information (e.g., timestamp(s), etc.) of a set of images/videos captured by the image capturing device) and an electronic labeling device (which determines the timing information (e.g., timestamp(s), etc.) of a set of labels selected via the electronic labeling device). In the example of FIG. 4, the time-dependent pattern is generated and the synchronization image is captured prior to capturing the set of images/videos, but in other examples the time-dependent pattern is generated and the synchronization image is captured at another time, such as after capturing the set of images/videos.

In some examples, the time relationship between the image capturing device and the electronic labeling device is a timing unit offset between the image capturing device and the electronic labeling device. The timing unit offset between the image capturing device and the electronic labeling device is the difference between the real-time of the timing unit of the image capturing device and the real-time of the timing unit of the electronic labeling device. For example, if the timing unit of the image capturing device read 1:30:05 PM (e.g., via a generated timestamp of an image, etc.) at the same time the timing unit of the electronic labeling device read 1:30:00 PM (e.g., via a generated timestamp of a label, etc.), the timing unit offset between the image capturing device and the electronic labeling device is that the image capturing device is 5 seconds ahead of the electronic labeling device.

The time relationship (e.g., timing unit offset, etc.) between the image capturing device and the electronic labeling device determines a time relationship (e.g., time difference, etc.) between the set of images/videos captured by the image capturing device (as indicated by the timing information such as timestamp(s) of the set of images) and the set of labels selected via the electronic labeling device (as indicated by the timing information such as timestamp(s) of the set of labels). For the same example with a time relationship wherein the timing unit of the image capturing device indicates a time 5 seconds ahead of the time indicated by the timing unit of the electronic labeling device, an example image has a timestamp of 1:31:05 PM and an example label has a timestamp of 1:31:02 PM. Although the label has an earlier timestamp than the image, once the time relationship between the set of images/videos and the set of labels (e.g., 5 seconds) is taken into account, it can be determined that the label was selected 2 seconds after the image was captured (e.g., at times 1:31:05 PM and 1:31:07 PM per the image capturing device and at times 1:31:00 PM and 1:31:02 PM per the electronic labeling device.

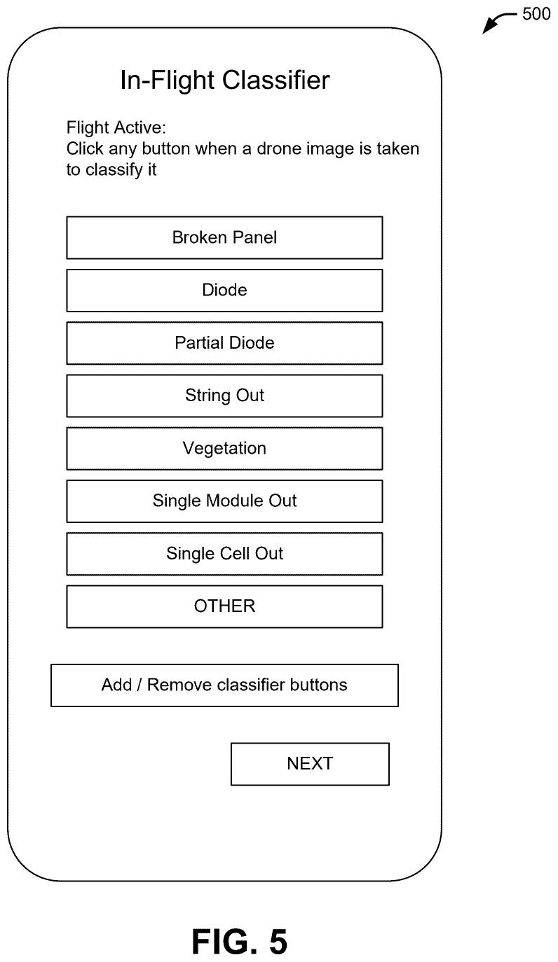

Referring to FIG. 5, illustrated is an example image of an electronic labeling device 500 (e.g., a mobile device executing an app, as an example of the electronic labeling device 130, etc.) showing a set of displayed labels for real-time classification of images related to failures in PV modules. At or around the time a user captures an image with an associated image capturing device (e.g., the image capturing device 110, which in some examples is an image capturing device of a UAV/drone, etc.), the user selects a label from the set of displayed labels, which creates a label that includes label timing information indicating when (e.g., per a local timing unit, relative to a synchronization output, etc.) the label was created or selected. The example set of displayed labels shown on the electronic labeling device 500 includes multiple common causes of PV failures and an “OTHER” label (e.g., which a user can select for images that do not correspond to any displayed labels, allowing a user to add a label later, such as during review, etc.). Additionally, the electronic labeling device 500 shows an option for modifying the set of displayed labels. In some examples, the set of displayed labels is selected by a user based on a scenario or context for capturing the set of images. In various such examples, the selected set of displayed labels is a predetermined set, a predetermined set that was modified by a user (e.g., and saved for later use, etc.), a user-generated set, etc.

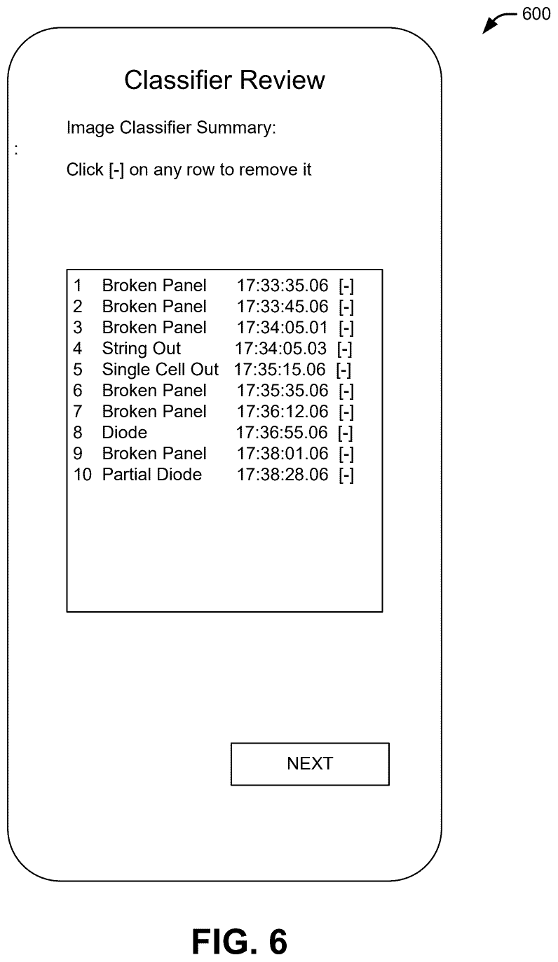

Referring to FIG. 6, illustrated is an example image of an electronic labeling device 600 (e.g., a mobile device executing an app, as an example of an electronic labeling device 130, etc.) showing a set of labels with associated timing information for user review. In various examples, user review of a set of labeled images allows for a user to change a label (e.g., to another label of the set of displayed labels or to a different label, etc.), remove a labeled image, etc. In the example of FIG. 6, each of the labels is demonstrated as having a timestamp that corresponds to a time when the corresponding label was selected from the list (e.g., as demonstrated in the example of FIG. 5), such as to coincide with a captured image (e.g., from the image capturing device 110).

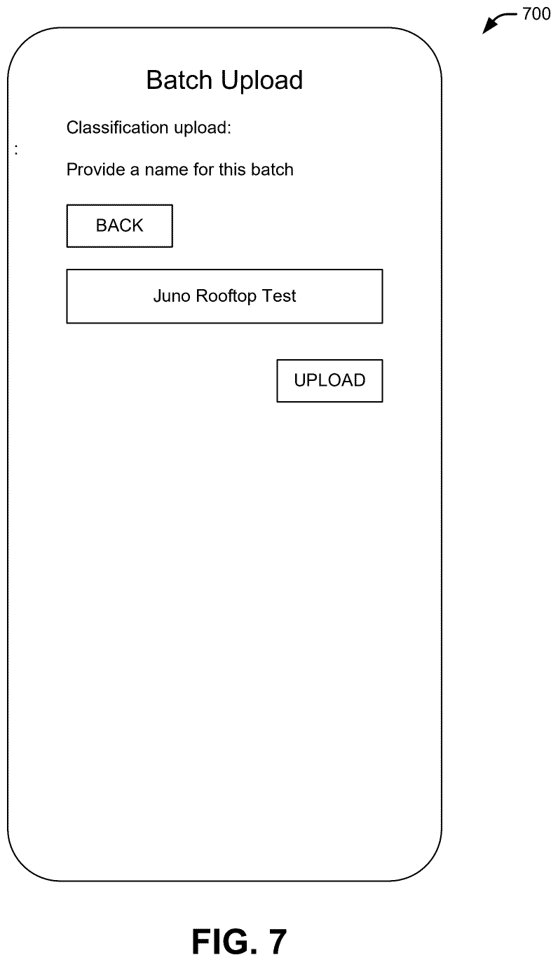

FIG. 7 illustrates an example image of an electronic labeling device 700 (e.g., a mobile device executing an app, as an example of an electronic labeling device 130, etc.) showing options to name and upload a set of labeled images to a server. In the example of FIG. 7, a name has been entered for the set of labeled images captured (e.g., via the image capturing device 110) during a session (e.g., a UAV flight over a rooftop, etc.).

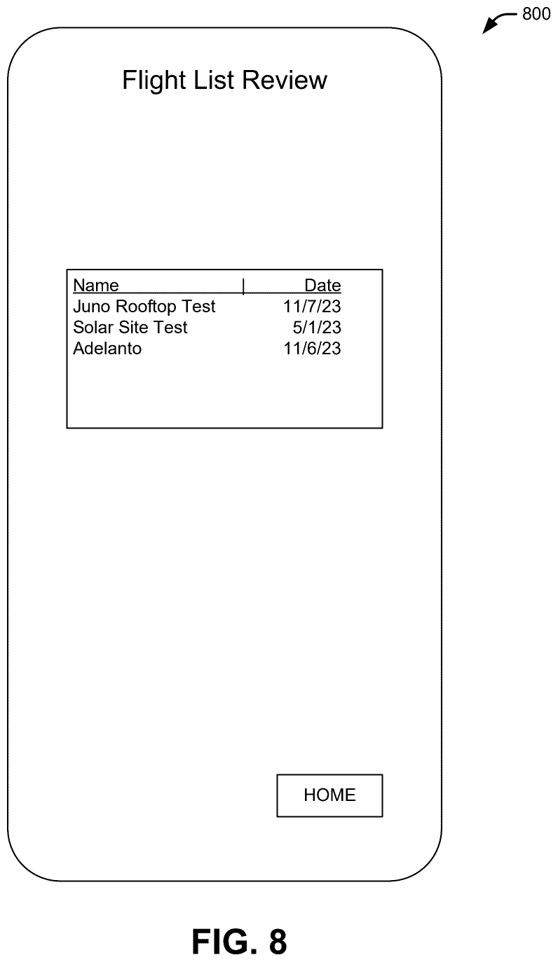

FIG. 8 illustrates an example image of an electronic labeling device 800 (e.g., a mobile device executing an app, as an example of an electronic labeling device 130, etc.) showing multiple sets of labeled images uploaded to a server and available for viewing and/or reviewing. Each of the named sets of labeled images shown in FIG. 8 include images captured (e.g., via the image capturing device 110) during a different session (e.g., a UAV flight over a rooftop as in FIG. 7, a UAV flight over a solar site, etc.)

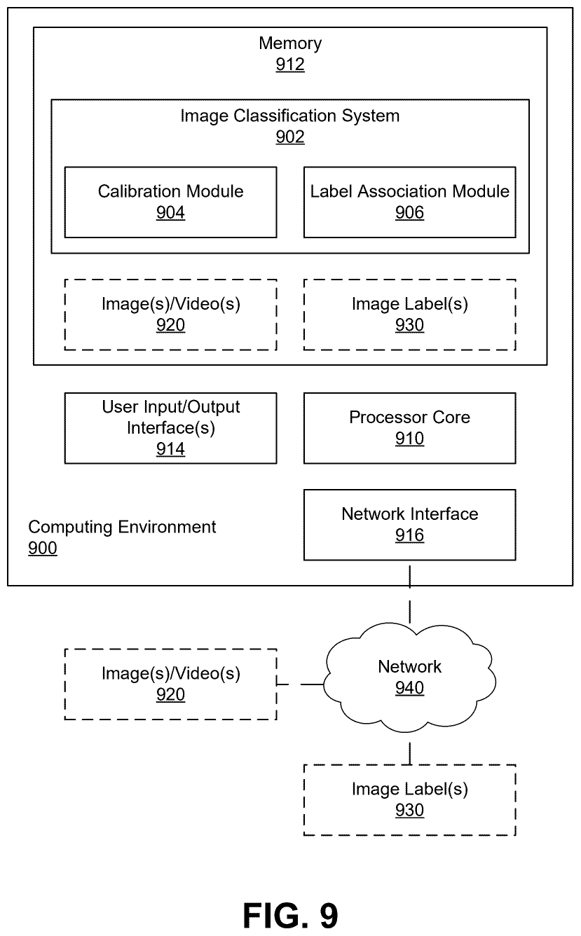

FIG. 9 illustrates an example computing environment 900 implementing an image classification system 902 (e.g., which is one example of the image classification system 150, etc.) capable of classifying images/videos via associating the images/videos with user-selected labels. In various examples, the image classification system 902 includes a calibration module 904 that determines a time relationship (e.g., relative time difference, etc.) and/or location offset between images/videos and labels, and a label association module 906 that associates labels with images/videos.

The computing environment 900 includes a processor core 910, a memory 912, a user input/output (I/O) interface 914, and a network interface 916, which are operably connected for computer communication. The processor core 910 performs general computing to execute instructions stored in the memory 912, including instructions associated with the image classification system 902. The instructions cause the processor core 910 to execute operations. The memory 912 also stores instructions associated with an operating system that controls and/or allocates resources of computing environment 900, including resources associated with the image classification system 902. The memory 912 represents a non-transitory machine-readable memory (or other medium), such as random-access memory (RAM), a solid state drive, a hard disk drive or a combination thereof.

The image classification system 902 includes a calibration module 904 that determines a time relationship (e.g., relative time difference, etc.) and/or location offset between images/videos and labels, and a label association module 906 that associates labels with images/videos. The memory 912 stores machine-readable instructions associated with the calibration module 904 and the label association module 906.

The set of images/videos 920 includes images/videos captured by an image capturing device (e.g., the image capturing device 110, a camera, etc.) and image(s)/video(s) of the set of images/videos 920 include image timing information (e.g., timestamp(s), etc.) and/or image location(s) for the image/video. The set of labels 930 includes user-selected labels (e.g., via the electronic labeling device 130, etc.) and label(s) of the set of labels 930 include label timing information (e.g., timestamp(s), etc.) and/or location(s) for the label. Depending on the example, the sets of images/videos 920 and/or the sets of image/video labels 930 can be stored locally to (e.g., stored within the memory 912, as shown in FIG. 9), remotely from (e.g., connected via a network 940, as shown in FIG. 9), or a combination of locally to and remotely from the computing environment 900.

The processor core 910 accesses the memory 912 and executes the machine-readable instructions as operations. The processor core 910 can be a variety of various processors including multiple single-and multi-core processors, co-processors, and other multiple single and multicore processor and co-processor architectures.

The user I/O interface 914 provides software and hardware to facilitate data input and output between the computing environment 900 and a user. This can include input devices such as a keyboard, mouse, touchpad, touchscreen, microphone, etc., as well as output devices such as display(s) (e.g., light-emitting diode (LED) display panel(s), liquid crystal display (LCD) panel(s), plasma display panel(s), and/or touch screen display(s), etc.), speaker(s), etc. The user I/O interface 914 provides graphical input controls for a user interface, which can include software and hardware-based controls, interfaces, touch screens, or touch pads or plug and play devices for a user to provide user input.

The network interface 916 provides software and hardware to facilitate data input to (e.g., sets of images/videos 920, sets of image/video labels 930, etc.) and output from (e.g., a set of labeled images/videos based on associating image labels 930 with images/videos 920, etc.) the computing environment 900.

The memory 912 includes the image classification system 902 that includes modules 904 and 906 that operate in concert and/or stages to generate a set of labeled images/videos from a set of images/videos 920 and a set of labels 930.

In various examples, the calibration module 904 accesses the set of images/videos 920 and the set of labels 930 and determines a relative time or time relationship (e.g., timing unit offset, time difference, etc.) and/or location (e.g., location offset, etc.) between the set of images/videos 920 and the set of labels 930. In some examples, the calibration module 904 determines the relative time based on accessing a synchronization image of a time-dependent pattern (e.g., a QR code) that was displayed on an electronic labeling device (e.g., the electronic labeling device 130, etc.) and captured via an image capturing device (e.g., the image capturing device 110, etc.). The calibration module 904 determines the time relationship by comparing timing information of the synchronization output (e.g., time-dependent pattern, etc.) generated by the electronic labeling device with timing information of the synchronization data point captured by the image capturing device (e.g., an image of the time-dependent pattern, etc.). By comparing the synchronization timing information from the timing unit of the electronic labeling device with the synchronization timing information from the image capturing device, the calibration module 904 determines a time relationship (e.g., time difference, elapsed time since a synchronization output/data point, and/or relative time, etc.) between the set of images/videos 920 from the image capturing device and the set of labels 930 from the electronic labeling device. Additionally, in various examples, the calibration module 904 also compares timing information of the set of images/videos 920 with timing information of the set of labels 930 (e.g., as adjusted based on the determined time relationship, etc.) to estimate a user delay or range of user delays between capturing images and selecting labels.

The label association module 906 associates labels of the set of labels 930 with images/videos of the set of images/videos 920. In various examples, the label association module 906 associates a label with an image/video based on one or more of label timing information of the label, image/video timing information of the image/video, a time relationship between the set of labels 930 and the set of images/videos 920, a time threshold for label selection, and/or an estimated user delay between the set of images/videos 920 and the set of labels 930. The label association module 906 outputs a set of labeled images, indicating the associations between labels and images/videos. In some scenarios, user feedback is received in response to the set of labeled images/videos or a subset of the set of labeled images/videos (e.g., images/videos designated for user review, etc.), and the label association module 906 updates the set of labeled images/videos based on the received user feedback (e.g., replacing a first label with a second label, such as replacing an “other” label with a user-generated label, adding a label to an image unassociated with a label, choosing between multiple labels selected at or near the time an image/video was captured, etc.). In various examples, the label association module 906 sorts the set of labeled images/videos based on the labels associated with the images/videos.

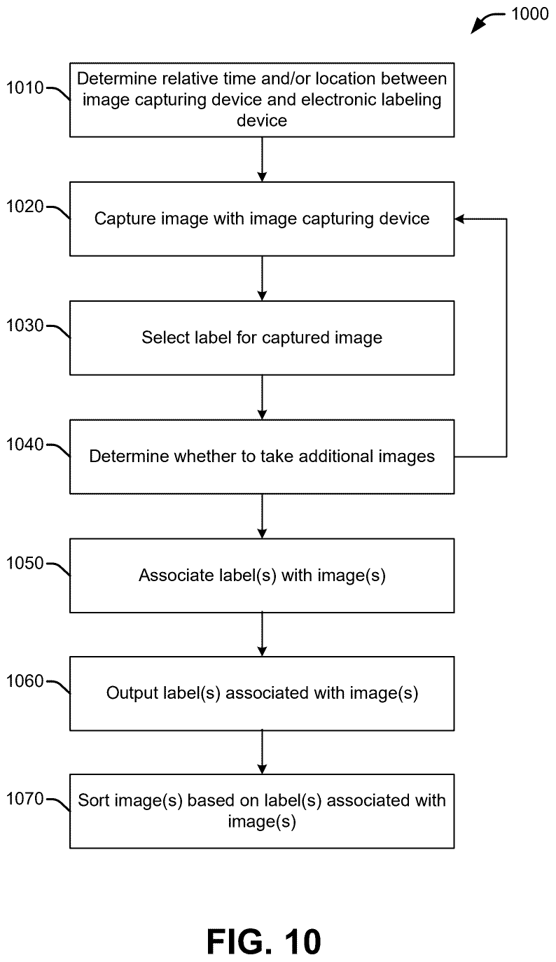

In view of the foregoing structural and functional features described above, an example method will be better appreciated with reference to FIG. 10. While, for purposes of simplicity of explanation, the example method of FIG. 10 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

Referring to FIG. 10, illustrated is a flow diagram of a method 1000 of classifying images in real-time based on user input. In other examples, the blocks of the example method 1000 are a set of machine-readable instructions on a non-transitory machine-readable medium or are a set of operations performed by a processor executing machine-readable instructions as the operations.

At block 1010, method 1000 includes determining a relative time and/or location between an image capturing device (e.g., the image capturing device 110, a camera, etc.) and an electronic labeling device (e.g., the electronic labeling device 130, etc.), such as based on a synchronization image of a time-dependent pattern (e.g., QR code, etc.).

At block 1020, method 1000 includes capturing an image/video (e.g., based on a user input, etc.) with the image capturing device.

At block 1030, method 1000 includes selecting a label (e.g., based on a user input, etc.) for the captured image/video with the electronic labeling device.

At block 1040, method 1000 includes determining whether to capture additional image(s)/video(s). If a determination is made to capture additional image(s)/video(s), method 1000 returns to block 1020. If a determination is made not to capture additional image(s)/video(s), method 1000 proceeds to block 1050.

At block 1050, method 1000 includes associating the label(s) with the image(s)/video(s) (e.g., via an image classification system 150 or image classification system 902, etc.).

At block 1060, method 1000 includes outputting an indication of the label(s) associated with the image(s)/video(s), such as via a set of labeled images/videos. In some examples, user feedback is received in response to the set of labeled images/videos.

At block 1070, method 1000 includes sorting the image(s)/video(s) based on the label(s) associated with the image(s)/video(s).

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Also as used herein, the term “set” means one or more elements (e.g., where the elements can be anything, such as datasets, nodes, relationships, etc.), and a “subset” of a set A refers to any set B where every element of set B is an element of set A (note that every set A is a subset of itself, as every element of set A is an element of set A). Similarly, a “proper subset” of set A refers to a set B that does not include every member of the set A, such that set A and set B are not equal. Additionally, where the disclosure or claims recite “a,” “an,” “a first,” or “another” element, or the equivalent thereof, it should be interpreted to include one or more than one such element, neither requiring nor excluding two or more such elements.

In this description, unless otherwise stated, “about,” “approximately” or “substantially” preceding a parameter means being within +/−10 percent of that parameter. Modifications are possible in the described embodiments, and other embodiments are possible, within the scope of the claims.

What is claimed is:

1. A system, comprising:
an image capturing device configured to capture a set of images based on a first set of user inputs, wherein an image of the set of images comprises image timing information;
an electronic labeling device configured to generate a set of labels based on a second set of user inputs, wherein a label of the set of labels comprises label timing information;
a memory for storing machine-readable instructions; and
a processor core for accessing the machine-readable instructions and executing the machine-readable instructions as operations, the operations comprising:
accessing the set of images and the set of labels;
determining a time relationship between the image capturing device and the electronic labeling device;
associating the label with the image based on the image timing information, the label timing information, and the time relationship; and
outputting an indication of the association of the label with the image.

2. The system of claim 1, wherein the electronic labeling device generates a synchronization output, the image capturing device captures a synchronization data point based on the synchronization output, and the time relationship is determined based on the synchronization output and the synchronization data point.

3. The system of claim 2, wherein the time relationship between the image capturing device and the electronic labeling device is a time offset between first timing information associated with the synchronization output and second timing information associated with the synchronization data point.

4. The system of claim 1, wherein associating the label with the image is further based on a time threshold for label selection.

5. The system of claim 1, wherein the label is selected from a set of displayed labels on the electronic labeling device.

6. The system of claim 1, wherein the image is a first image of the set of images and the image timing information is first image timing information, and a second image of the set of images is associated with the label based on second image timing information, the label timing information, and the time relationship.

7. The system of claim 1, wherein associating the label with the image is further based on an estimated user delay associated with a user.

8. The system of claim 1, wherein the operations further comprise receiving user feedback to the association of the label with the image.

9. The system of claim 1, wherein the image capturing device is on an unmanned aerial vehicle (UAV) controlled via the first set of user inputs.

10. A non-transitory machine-readable medium having machine executable instructions for an image classification system that causes a processor core to execute operations, the operations comprising:
accessing a set of images, wherein an image of the set of images comprises image timing information;
accessing a set of user-selected labels, wherein a label of the set of user-selected labels comprises label timing information;
determining a time relationship between the set of images and the set of user-selected labels;
associating the label with the image based on the image timing information, the label timing information, and the time relationship; and
outputting an indication of the association of the label with the image.

11. The non-transitory machine-readable medium of claim 10, wherein the operations further comprise accessing a synchronization image of a time-dependent pattern, wherein the synchronization image comprises synchronization timing information, and the time relationship is determined based on a first time determined from the time-dependent pattern and a second time determined from the synchronization timing information.

12. The non-transitory machine-readable medium of claim 11, wherein the time-dependent pattern comprises a quick-response (QR) code.

13. The non-transitory machine-readable medium of claim 10, wherein associating the label with the image is further based on a time threshold for label selection.

14. The non-transitory machine-readable medium of claim 10, wherein the operations further comprise receiving user feedback to the association of the label with the image.

15. The non-transitory machine-readable medium of claim 14, wherein the label is a first label and wherein the operations further comprise associating a second label with the image based on the user feedback.

16. A method, comprising:
accessing an image comprising image timing information from a memory;
accessing a label input from the memory, the label input comprising a label and label timing information;
determining a time relationship between the image and the label based on the image timing information and the label timing information;
associating the label with the image based on the time relationship to generate a labeled image comprising the image and the label; and
outputting the labeled image.

17. The method of claim 16, further comprising accessing first timing information of a synchronization output associated with the label and second timing information of a synchronization data point associated with the image, wherein the time relationship is determined based on the first timing information and the second timing information.

18. The method of claim 17, wherein the time relationship is a time offset between the first timing information and the second timing information.

19. The method of claim 16, wherein associating the label with the image is further based on a time threshold for label selection.

20. The method of claim 16, wherein the image is a first image of a set of images, the image timing information is first image timing information, and the time relationship is a first time relationship, the method further comprising:
accessing a second image from the set of images, the second image comprising second image timing information from the memory;
determining a second time relationship between the second image and the label based on the second image timing information and the label timing information;
associating the label with the second image based on the second time relationship to generate a second labeled image comprising the second image and the label; and
outputting the second labeled image.
